(19) United States
(12) Patent Application Publication
(10) Pub. No.: US 2014/0211474 A1
(43) Pub. Date: Jul. 31, 2014

(54) ENERGY-SAVING AND EXPLOSION-PROOF LED LAMP

(71) Applicant: LI-HONG TECHNOLOGICAL CO., LTD., Kaohsiung City (TW)

(72) Inventors: Ching-Yuan JUAN, Kaohsiung City (TW); Kun-Jung CHANG, Kaohsiung City (TW); Kuo-Chun LIN, Kaohsiung City (TW); Ching-Huang JUAN, Kaohsiung City (TW); HAN-WEN CHANG, Kaohsiung City (TW)

(73) Assignee: LI-HONG TECHNOLOGICAL CO., LTD., Kaohsiung City (TW)

(21) Appl. No.: 13/751,905

(22) Filed: Jan. 28, 2013

(51) Int. Cl. F21V 15/01

(52) U.S. Cl. CPC F21V 15/01
USPC 362/267

(57) ABSTRACT

An energy-saving and explosion-proof LED lamp comprises a lamp socket, an LED element, a lamp shade and a ring cap. The lamp socket includes a housing chamber, a jutting coupling portion with a housing compartment at the bottom thereof to hold a washer assembly inside to seal the bottom of the lamp socket. The LED element is fixedly held in the housing chamber. The lamp shade is made of tempered glass and wedged in the housing chamber, and has a jutting lens in the center and an annular end extended outwards from the perimeter of the lens. The ring cap has a coupling opening mating the lens and a press portion at the rim thereof. The ring cap is coupled on the lamp socket with the press portion covering the annular end, thus forms a flame propagation distance complying with explosion-proof certification.

### FIELD OF THE INVENTION

The present invention relates to a lamp and particularly to an energy-saving and explosion-proof LED lamp complying with explosion-proof certification.

### BACKGROUND OF THE INVENTION

At sites of hazardous industries such as chemical industry, petrochemical industry, oilfields, coalmines and the like, there are gases and chemicals with inflammable, explosive, oxidization and corrosion characteristics, hence explosion-proof lamps must be used to avoid possible gas explosion caused by bursting sparks generated by ordinary lamps.

The explosion-proof lamp means a safety lamp including a glass lamp shade, a metal shield and a sealing ring, which is waterproof and dustproof to prevent ingress of inflammable gases. The conventional explosion-proof lamps mostly adopt a large light bulb with a high power incorporating with a metal shell to provide desired illumination. Such a structure creates a lot of shortcomings, such as great power consumption, bulky size, heavy weight and shortened lifespan. On a large-scale explosion-proof lamp, in order to comply with explosion-proof certification and general safety regulations, the structural design in heat dissipation and the material selection have to be improved. Moreover, installation and positioning of the large-scale explosion-proof lamp is inconvenient due to its bulky size and heavy weight. In addition, a cable of the conventional explosion-proof lamp must be tightly coupled with an extra cable gland. While the cable gland can securely fasten the cable to provide enhanced pulling force resistance and air-tightness, it also increases the production cost of the lamp. All these show that there are still rooms for improvement.

### SUMMARY OF THE INVENTION

The primary object of the present invention is to solve the problems of the conventional explosion-proof lamps such as bulky size, great power consumption, and inconvenient installation by providing an improved lamp incorporating with an LED substrate to improve usability and practicality such as energy saving and carbon reduction.

To achieve the foregoing object, the present invention provides an energy-saving and explosion-proof LED lamp that includes a lamp socket, an LED element, a lamp shade and a ring cap. The lamp socket includes a housing chamber, and a jutting coupling portion at the bottom thereof with a housing compartment formed therein to hold a washer assembly inside. The coupling portion includes a bottom edge bent towards the center by a metal pressing process to form tight coupling with the washer assembly for retaining thereof to seal the bottom of the lamp socket. The LED element is fixedly held in the housing chamber. The lamp shade which is made of tempered glass is wedged in the housing chamber and includes a jutting lens in the center and an annular end extended outwards from the perimeter of the lens. The ring cap includes a coupling opening corresponding to the lens and a press portion at the rim of the coupling opening to cover the annular end after the ring cap is coupled on the lamp socket.

By means of the aforesaid structure, the invention provides many advantages, notably:

1. The invention employs the LED as the lighting element. The LED is smaller in size and less likely to burst, hence not only can reduce the probability of explosion, but also can save energy and reduce carbon emission.

2. The invention is compact in size and has higher power efficiency. Through the coupling portion, a single modular design can be formed. Not only installation and positioning can be easier, but also heat dissipation and cooling efficiency can be improved by incorporating with metal elements having greater heat conduction and cooling characteristics, thus the application scope of the explosion-proof lamp can be expanded.

3. The invention provides a simpler structural design. Not only the structural strength is higher, a sufficient flame propagation distance also is provided inside the lamp to comply with the explosion-proof certification, and to maintain the surface temperature of the lamp below the ignition point to reduce the probability of industrial accidents to provide better protection for human being.

4. The invention does not need screw fastening during assembly of various elements and extra cable gland. Hence installation time can be shortened and production cost can be reduced, and production yield rate of the finished products of the lamps also improves.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the invention.

FIG. 2 is an exploded view of the invention.

FIG. 3 is a sectional view of a first embodiment of the invention in an assembled condition.

FIG. 4 is another sectional view of the first embodiment of the invention.

FIG. 5 is a schematic view of an embodiment of the invention in a use condition.

FIG. 6 is a schematic view of an embodiment of the invention in another use condition.

FIG. 7 is a front view of a second embodiment of the invention.

FIG. 8 is a bottom view of the second embodiment of the invention.

FIGS. 9a through 9c are schematic views of the second embodiment of the invention during installation.

FIG. 10 is a front view of a third embodiment of the invention.

### DETAILED DESCRIPTION OF THE PREFERRED EMBODIMENTS

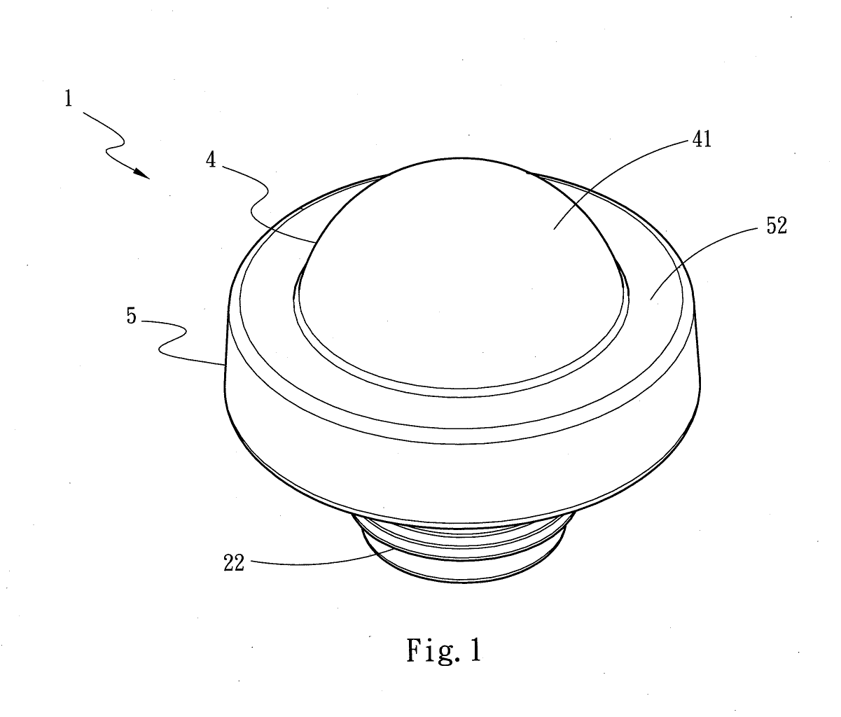

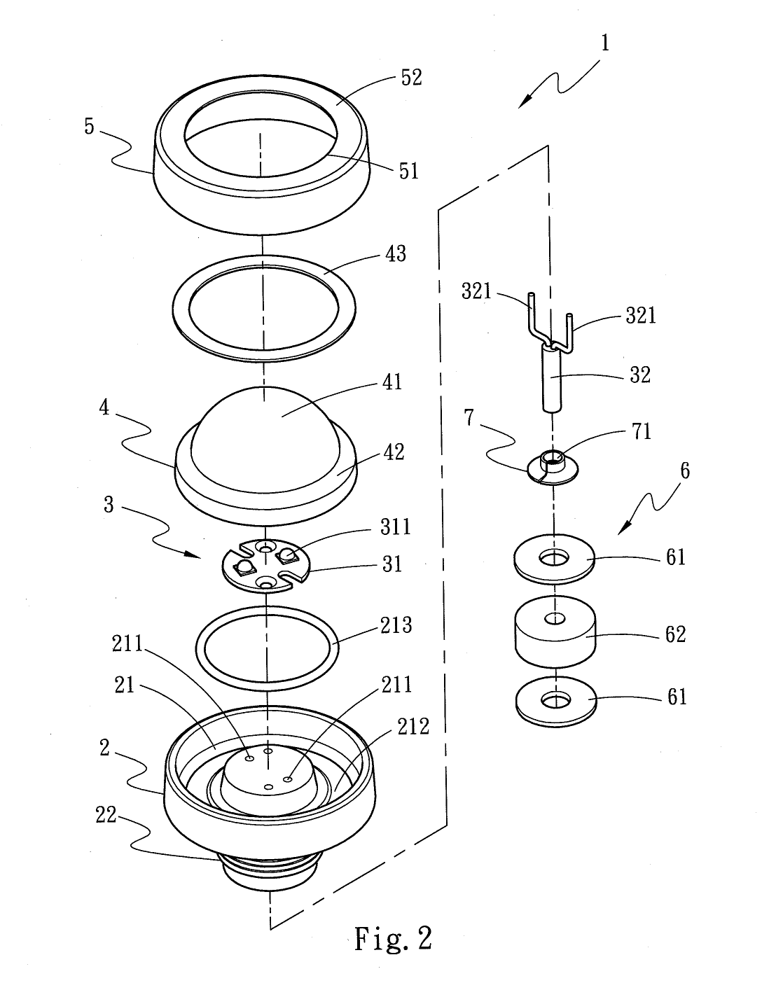

Please refer to FIGS. 1, 2 and 3 for a first embodiment of the present invention. The invention provides an energy-saving and explosion-proof LED lamp 1 which comprises a lamp socket 2, an LED element 3, a lamp shade 4 and a ring cap 5. The lamp socket 2 includes a housing chamber 21, two electrode apertures 211 formed in a center of the housing chamber 21, and a jutting coupling portion 22 at a bottom thereof. The coupling portion 22 includes a thread section 221 on the circumference and a housing compartment 23 with an opening facing downward. The housing compartment 23 holds a washer assembly 6 inside. The washer assembly 6 includes a rubber pad 62 and two metal washers 61 respectively bonded to an upper surface and a lower surface of the rubber pad 62. The coupling portion 22 includes a bottom edge bent towards the center by a metal pressing process to form tight coupling with the metal washer 61 to seal the bottom of the lamp socket 2.

The LED element 3 includes an LED substrate 31 and a cable 32. The LED substrate 31 includes at least one LED 311 and is fixedly held in the housing chamber 21. The cable 32 is held in the housing compartment 23 and runs through a center of the washer assembly 6. The cable 32 includes two electrode wires 321 respectively running through the two electrode apertures 211 to form electric connection with the LED substrate 31.

The lamp shade 4 which is made of a tempered glass includes a jutting lens 41 in the center and an annular end 42 extended outwards from the perimeter of the lens 41. The lamp shade 4 is wedged in the housing chamber 21 to encase the LED substrate 31 with the bottom surface of the annular end 42 butting the bottom rim of the housing chamber 21.

The ring cap 5 includes a coupling opening 51 corresponding to the lens 41 and a press portion 52 at a rim of the coupling opening 51 to cover the annular end 42 after the ring cap 5 is coupled on the lamp socket 2.

The housing chamber 21 further includes an annular groove 212 at a bottom circumference thereof to hold an. annular ring 213 for buffering. The annular end 42 of the lamp shade 4 also can be coupled with a silicon padding ring 43 which is sandwiched between the annular end 42 and press portion 52 of the ring cap 5 to enhance air-tightness and water-proof characteristics.

The energy-saving and explosion-proof LED lamp 1 of the invention further includes a cable clamp 7 which is held in the housing compartment 23 and located above the washer assembly 6 and includes a clip 71 to securely hold the cable 32 to prevent from loosening off or separating caused by external factors such as weight or stretching.

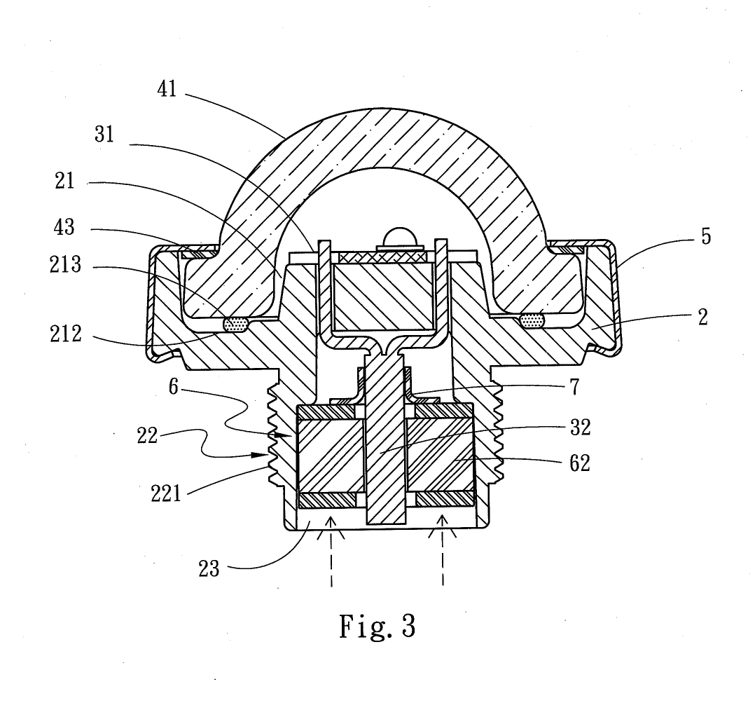

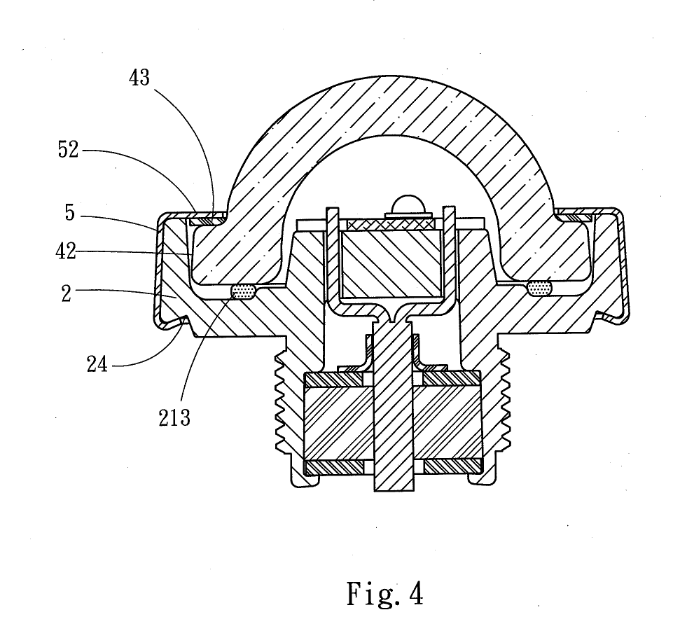

Please also refer to FIGS. 3 and 4. During assembly of the invention, first, the LED substrate 31 is fixedly held in the housing chamber 21 and the cable 32 is then disposed in the housing compartment 23 to form electric connection with the LED substrate 31; next, the annular ring 213 is held in the annular groove 212 at the bottom of the housing chamber 21, and then the lamp shade 4 coupled with the silicon padding ring 43 is wedged in the housing chamber 21 to encase the LED substrate 31; then, the ring cap 5 is coupled on the lamp socket 2; finally, the cable clamp 7 and washer assembly 6 is coupled on the cable 32 and squeezed into the housing compartment 23, and then the bottom edge of the coupling portion 22 is bent towards the center through a metal pressing process to tightly hold and confine the washer assembly 6. As the rubber pad 62 of the washer assembly 6 is resilient and can be deformed by squeezing, the bottom of the lamp socket 2 is formed in a good sealing state.

Please refer to FIG. 4 for another sectional view of the first embodiment in an assembled condition. The lamp socket 2 further includes an annular recess 24 on a bottom circumference thereof. After the ring cap 5 has been coupled on the lamp socket 2, the bottom end of the ring cap 5 is bent to latch on the recess 24 for fastening. The ring cap 5 covers the lamp shade 4 to form a flame propagation distance. Through the structure of the press portion 52 and annular end 42, the sufficient flame propagation distance can be provided to prevent sparks from escaping to ignite external gases or powders to cause explosion or combustion. Moreover, aside from disposing the annular ring 213 and silicon padding ring 43 between the press portion 52 and annular end 42 to provide buffering and sealing effects, the gaps formed between them also can be filled with explosion-proof clay to further enhance leakage-proof effect. This is a technique known in the art, details are omitted herein.

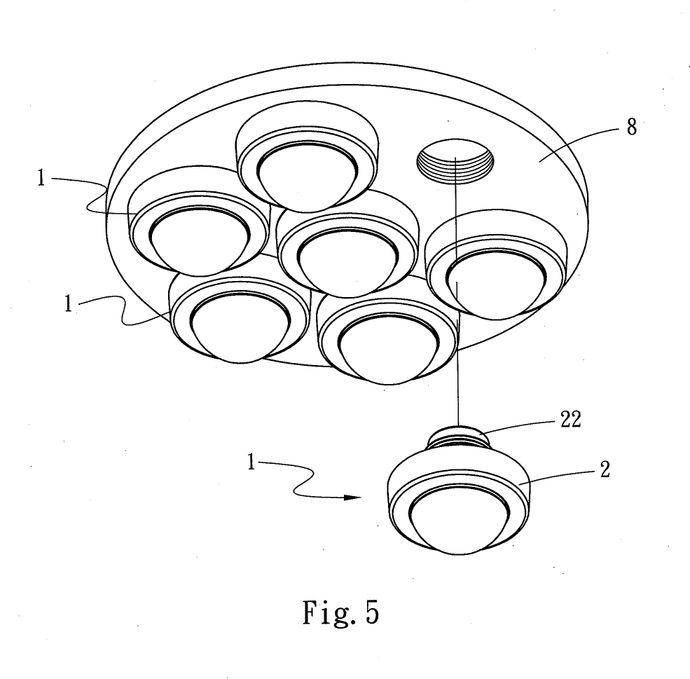

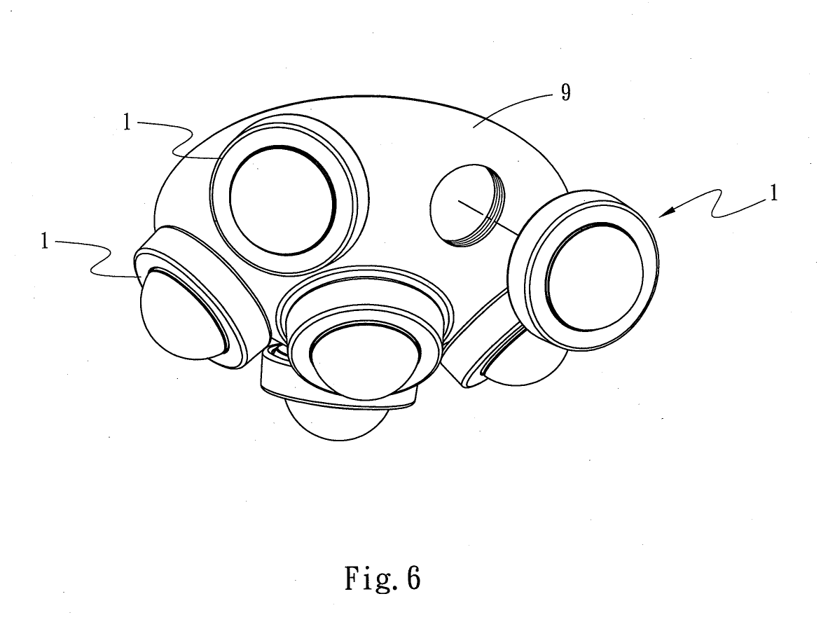

Please refer to FIGS. 5 and 6 for the invention in use conditions. Through the thread section 221 formed on the coupling portion 22, a desired number of the energy-saving and explosion-proof LED lamps 1 can be quickly fastened to corresponding screw holes of a board 8 or a lighting socket 9. Such a design allows users to adjust the illumination according to actual requirements, hence can improve usability.

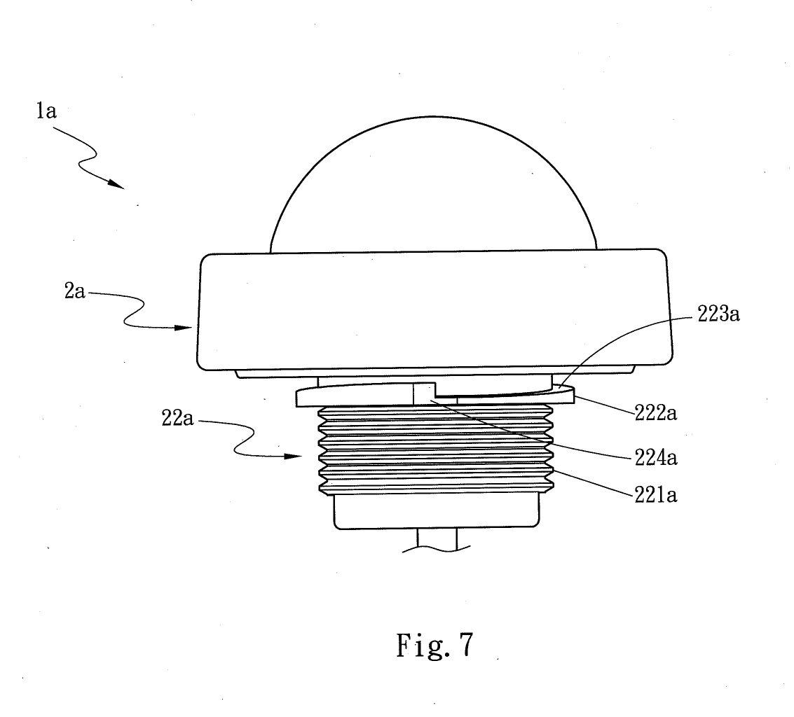

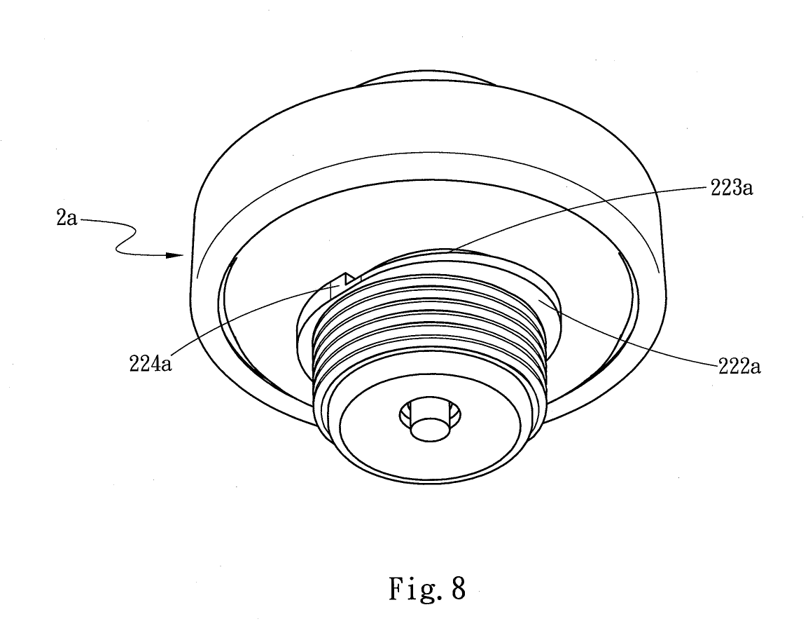

Please refer to FIGS. 7 and 8 for a second embodiment of the invention. The main feature of the energy-saving and explosion-proof LED lamp 1a is characterized in that the thread section 221a of the coupling portion 22a includes a chamfered portion 222a at the upper end. The chamfered portion 222a includes a helical sloped surface 223a at a top and an axial tangent surface 224a on at least one side thereof.

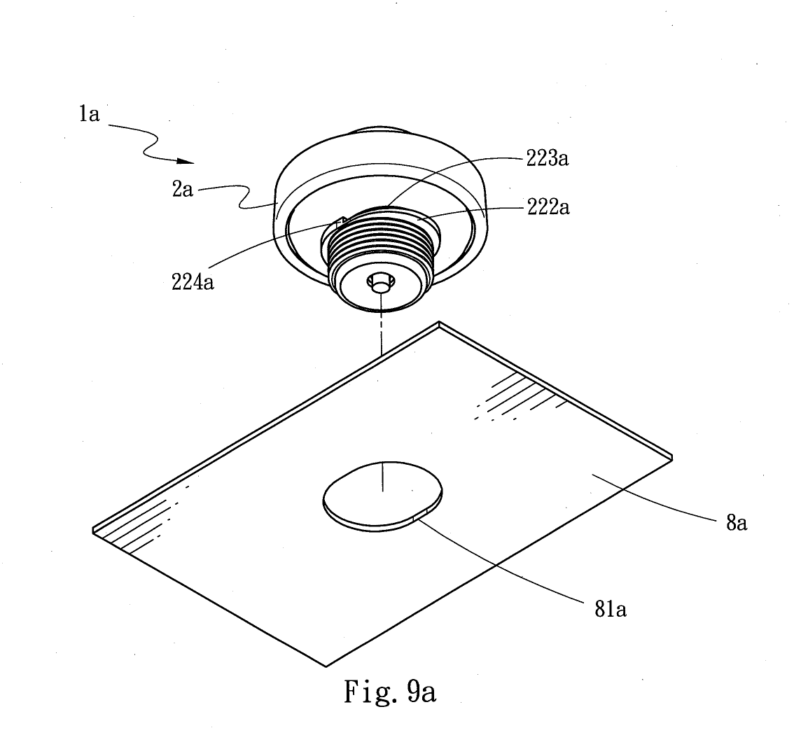

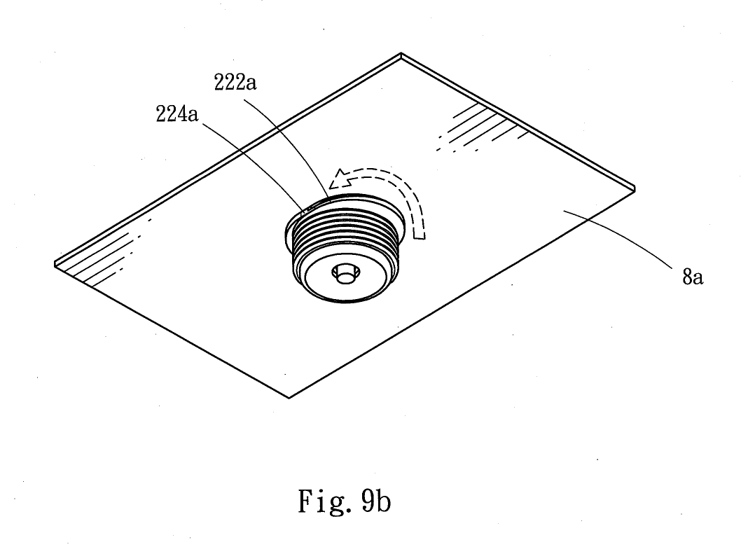

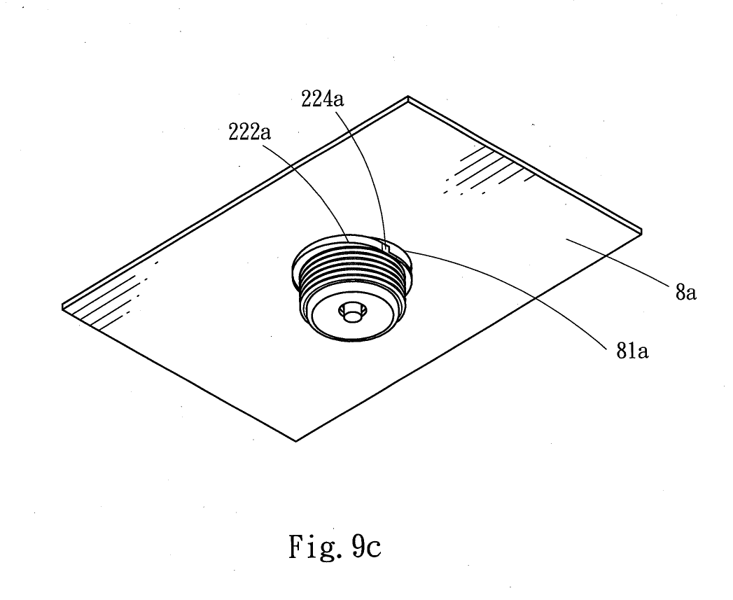

Also referring to FIGS. 9a through 9c, during installation of the energy-saving and explosion-proof LED lamp 1a, only a board 8a or a lighting socket (not shown in the drawings) has to be prepared. The board 8a has at least one screw hole 81a mating the profile of the coupling portion 22a. After the coupling portion 22a has been inserted into the screw hole 81a, the lamp socket 2a is appropriately turned to allow the chamfered portion 222a to gradually press against the board 8a through the helical sloped surface 223a so that the lamp socket 2a can be securely held on the board 8a. Such a design makes installation faster and easier.

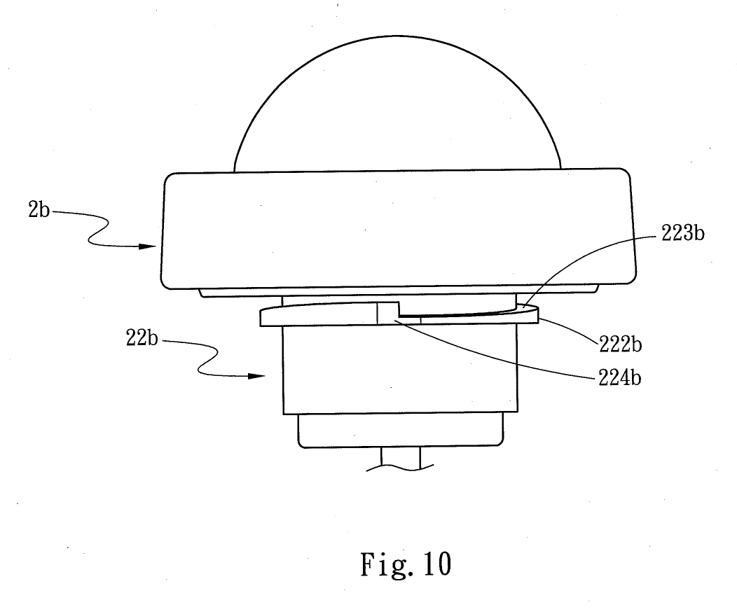

Please refer to FIG. 10 for a third embodiment of the invention. In practice, in order to reduce the production cost, the coupling portion 22b of the lamp socket 2b can be formed without the thread section. By providing merely the chamfered portion 222b with a helical sloped surface 223b at the top and a tangent surface 224b at one side thereof, assembly and disassembly also can be accomplished easier and production cost can be reduced to improve practicality.

What is claimed is:

1. An energy-saving and explosion-proof LED lamp, comprising:
a lamp socket including a housing chamber, two electrode apertures in a center of the housing chamber, and a jutting coupling portion at a bottom thereof that includes a housing compartment with an opening facing downward, the housing compartment holding a washer assembly inside;
an LED element including an LED substrate fixedly held in the housing chamber and a cable which is held in the housing compartment and runs through a center of the washer assembly and includes two electrode wires respectively running through the two electrode apertures to form electric connection with the LED substrate;
a lamp shade which is made of tempered glass and is wedged in the housing chamber to encase the LED substrate and includes a jutting lens in a center and an annular end extended outwards from a perimeter of the lens; and
a ring cap including a coupling opening corresponding to the lens and a press portion at a rim of the coupling opening to cover the annular end after the ring cap is coupled on the lamp socket.

2. The energy-saving and explosion-proof LED lamp of claim 1, wherein the coupling portion includes a thread section on a circumference thereof.

3. The energy-saving and explosion-proof LED lamp of claim 1, wherein the coupling portion includes a chamfered portion at an upper end that includes a helical sloped surface at a top and a tangent surface on at least one side thereof.

4. The energy-saving and explosion-proof LED lamp of claim 3, wherein the washer assembly includes a rubber pad and two metal washers respectively bonded to an upper surface and a lower surface of the rubber pad.

5. The energy-saving and explosion-proof LED lamp of claim 4, wherein the lamp socket further includes an annular recess on a bottom circumference thereof, the ring cap including a bottom end bent to latch on the annular recess for fastening.

6. The energy-saving and explosion-proof LED lamp of claim 5 further including a cable clamp which is held in the housing compartment and located above the washer assembly and includes a clip to securely hold the cable.

7. The energy-saving and explosion-proof LED lamp of claim 6, wherein the housing chamber includes an annular groove at a bottom circumference thereof to hold an annular ring, the annular end of the lamp shade being coupled with a silicon padding ring which is sandwiched between the annular end and the press portion of the ring cap.

8. The energy-saving and explosion-proof LED lamp of claim 2, wherein the coupling portion includes a chamfered portion at an upper end that includes a helical sloped surface at a top and a tangent surface on at least one side thereof.

9. The energy-saving and explosion-proof LED lamp of claim 8, wherein the washer assembly includes a rubber pad and two metal washers respectively bonded to an upper surface and a lower surface of the rubber pad.

10. The energy-saving and explosion-proof LED lamp of claim 9, wherein the lamp socket further includes an annular recess on a bottom circumference thereof, the ring cap including a bottom end bent to latch on the annular recess for fastening.

11. The energy-saving and explosion-proof LED lamp of claim 10 further including a cable clamp which is held in the housing compartment and located above the washer assembly and includes a clip to securely hold the cable.

12. The energy-saving and explosion-proof LED lamp of claim 11, wherein the housing chamber includes an annular groove at a bottom circumference thereof to hold an annular ring, the annular end of the lamp shade being coupled with a silicon padding ring which is sandwiched between the annular end and the press portion of the ring cap.
